(19) United States
(12) Patent Application Publication
(10) Pub. No.: US 2010/0117965 A1
(43) Pub. Date: May 13, 2010

(54) POINTING DEVICE WITH SECURING MECHANISM AND METHOD OF PROVIDING THE SAME

(75) Inventors: Mike Simonian, San Francisco, CA (US); Maaike Evers, San Francisco, CA (US); Adrian Sesto, Hermosa Beach, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/577,110

(22) Filed: Oct. 9, 2009

Related U.S. Application Data
(60) Provisional application No. 61/103,929, filed on Oct. 9, 2008.

(51) Int. Cl. G06F 3/033

(52) U.S. Cl. 345/164; 345/163

(57) ABSTRACT

Embodiments of pointing devices with securing mechanism and related methods are described herein. Other embodiments and related methods are also disclosed herein.

### CROSS REFERENCE TO RELATED APPLICATION

This application claims priority to U.S. Provisional Patent Application 61/103,929, filed on Oct. 9, 2008, the contents of which are incorporated herein by reference.

### FIELD OF THE INVENTION

This invention relates generally to computer input devices, and relates, more particularly, to computer mouse devices and related methods for controlling cursors on computer displays.

### BACKGROUND

The use of pointers on graphical user interfaces (GUIs) presented on a computer display device for interacting with application software is well known. Essentially all Windows® based, owned by Microsoft Corporation, or MAC® based, owned by Apple Computer, Inc., software utilizes such control.

A computer mouse device comprises a shell shaped to fit conveniently and comfortably in the palm of the hand of the user while it rests on a substantially flat, horizontal surface. Typically, a plurality of buttons are located on the top of the shell. A mechanism accessing the substantially flat, horizontal surface through the bottom of the shell is responsive to the user moving the mouse device on top of the substantially flat, horizontal supporting surface. This mechanism is typically a trackball sensor array protruding from the bottom of the computer mouse device or a small, red light-emitting diode (LED) that bounces light off that surface onto a complimentary metal-oxide semiconductor (CMOS) sensor.

Additionally, the mouse may be wireless in which case it may use radio frequency (RF) technology to communicate information to the computer. If the mouse is wireless and radio-based, the wireless mouse would include at least two main components: a transmitter and a receiver. The transmitter is housed in the mouse. The transmitter sends an electromagnetic (radio) signal that encodes the information about the mouse's movements and the buttons that are clicked. The receiver, which is connected to the computer, accepts the signal, decodes it and passes it on to mouse driver software and the computer's operating system. The receiver can be a separate device that plugs into the computer, a special card that is placed in an expansion slot or a built-in component.

In many instances, when the user is not using the mouse device or wishes to relocate a portable computing device (e.g., a laptop, a notebook, a netbook and the like), the mouse device is left on the supporting surface using up space and/or is forgotten on the supporting surface and must be retrieved later when the user realizes the mouse is not available at the computer's new location.

Therefore, a need exists in the art to develop a mouse device which provides facilities for storing the mouse device when not in use or when the computing device is being relocated to a new physical location.

### BRIEF DESCRIPTION OF THE DRAWINGS

The invention will be better understood from a reading of the following detailed description of examples of embodiments, taken in conjunction with the accompanying figures in the drawings in which:

FIG. 1 is an isometric view illustrating an exemplary mobile computing system for providing user input via a mobile input device, in accordance with the subject matter described herein.

FIG. 2 is an isometric view illustrating an exemplary mobile computing system for providing user input via a mobile input device wherein the mobile input device is in “storage mode,” in accordance with the subject matter described herein.

FIG. 3 is an isometric top-down view illustrating a mobile input device of the exemplary mobile computing system of FIG. 2 wherein the mobile input device is in “storage mode,” in accordance with the subject matter described herein.

FIG. 4 is an isometric bottom-up view illustrating a mobile input device of the exemplary mobile computing system of FIG. 2 wherein the mobile input device is in “storage mode,” in accordance with the subject matter described herein.

FIG. 5 is a front view illustrating a mobile input device of the exemplary mobile computing system of FIG. 2 wherein the mobile input device is in “storage mode,” in accordance with the subject matter described herein.

FIG. 6 is a side view illustrating a mobile input device of the exemplary mobile computing system of FIG. 2 wherein the mobile input device is in “storage mode,” in accordance with the subject matter described herein.

FIG. 7 is a top-down view illustrating a mobile input device of the exemplary mobile computing system of FIG. 2 wherein the mobile input device is in “storage mode,” in accordance with the subject matter described herein.

FIG. 8 is a bottom-up view illustrating a transmitter portion of a mobile input device of the exemplary mobile computing system of FIG. 2, in accordance with the subject matter described herein.

FIG. 9 is an isometric top-down view illustrating a receiver portion of a mobile input device of the exemplary mobile computing system of FIG. 2, in accordance with the subject matter described herein.

FIG. 10 is an isometric bottom-up view illustrating a receiver portion of a mobile input device of the exemplary mobile computing system of FIG. 2, in accordance with the subject matter described herein.

FIG. 11 is a top-down view illustrating a receiver portion of a mobile input device of the exemplary mobile computing system of FIG. 2, in accordance with the subject matter described herein.

FIG. 12 is a side view illustrating a receiver portion of a mobile input device of the exemplary mobile computing system of FIG. 2, in accordance with the subject matter described herein.

FIG. 13 is a flow chart illustrating an exemplary method of providing a portable pointing device assembly, in accordance with the subject matter described herein.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In one embodiment, a portable pointing device assembly can include: (a) a mobile pointing device having a top side and a bottom side, the top side having at least one user input, the bottom side having a sensor array, the mobile pointing device configured to receive user input and provide control data that is based on the user input to a computing device; (b) a first attraction strip coupled to the mobile pointing device; (c) a receiver dongle having a dongle housing and a dongle coupler in mechanical and electrical communication with the dongle housing, the dongle coupler in removable physical communication with the computing device, the receiver dongle in communication with the mobile pointing device, the receiver dongle configured to receive the control data from the mobile pointing device and provide the control data to the computing device; and (d) a second attraction strip coupled to the receiver dongle; wherein the first attraction strip and the second attraction strip are configured to magnetically couple together when the mobile pointing device is in proximity to the receiver dongle.

In another embodiment, a wireless portable device assembly can include: (a) a mobile pointing device having a top side and a bottom side, the top side having at least one user input, the bottom side having a sensor array and a mobile pointing device attraction strip, the mobile pointing device configured to receive user input and provide control data that is based on the user input to a computing device; and (b) a receiver dongle having a dongle housing and a dongle coupler in mechanical and electrical communication with the dongle housing, the dongle coupler in removable physical communication with the computing device, the dongle housing having a receiver dongle attraction strip, the receiver dongle in wireless communication with the mobile pointing device, the receiver dongle configured to receive the control data from the mobile pointing device and provide the control data to the computing device; wherein the mobile pointing attraction strip and the receiver dongle attraction strip are configured to be magnetically coupled together when the mobile pointing device is in proximity to the receiver dongle.

In yet another embodiment, a method for providing a portable pointing device assembly can include: providing a mobile pointing device; coupling a first attraction strip to the mobile pointing device; providing a receiver dongle; and coupling a second attraction strip to the receiver dongle; wherein the first attraction strip and the second attraction strip are configured to be magnetically coupled together when the mobile pointing device is in proximity to the receiver dongle.

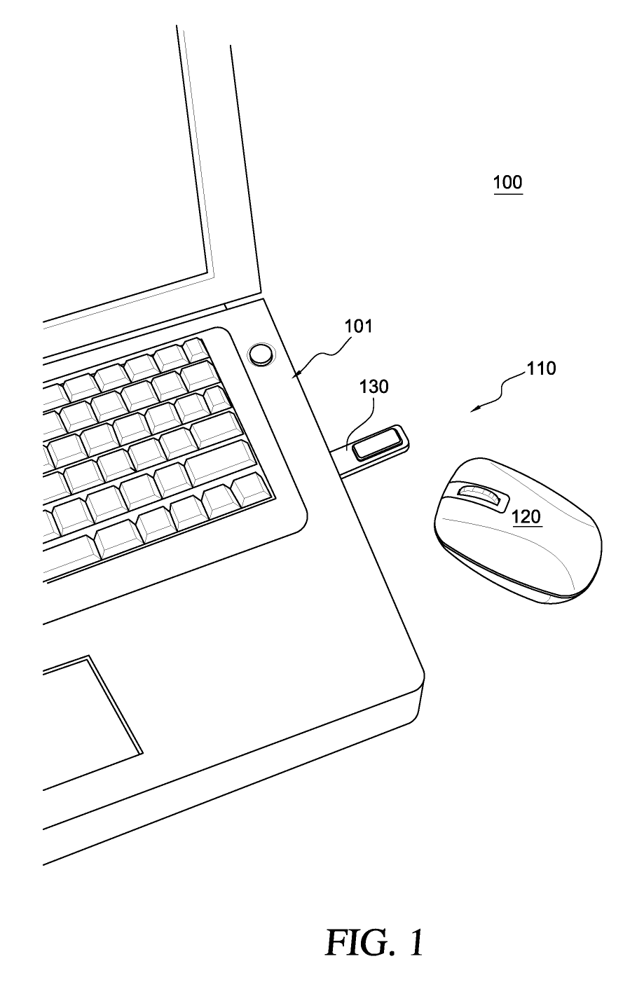

Turning to the drawings, FIG. 1 illustrates an exemplary mobile computing system 100 for providing user input via a mobile input device. FIG. 1 includes mobile computing device 101 and mobile user input device 110. Mobile user input device 110 includes mobile pointing device 120 and receiver dongle 130. In some embodiments, mobile pointing device 120 includes any and all necessary hardware, firmware and the like to perform some or all functionality associated with a mouse, such as, for example, click button functionality, scroll wheel functionality and the like. In some embodiments, mobile user input device 110 is implemented as a wireless user input device. In such embodiments, when mobile user input device 110 is implemented as a wireless user input device mobile pointing device 120 is implemented as a transmitter and receiver dongle 130 is implemented as a receiver. Mobile computing system 100 is merely exemplary and is not limited to the embodiments presented herein. Mobile computing system 100 can be employed in many different embodiments or examples not presented herein.

When mobile user input device 110 is implemented as a wireless user input device, as a user moves mobile pointing device 120, or clicks a button, operates a scroll wheel, and/or operates some such other function associated with mobile pointing device 120, mobile pointing device 120 sends an electromagnetic (radio) signal that encodes the information about the movements or the buttons that are clicked on mobile pointing device 120. This data is called control data, and the signal is a control signal. The control signal is sent from mobile pointing device 120 to receiver dongle 130. Receiver dongle 130, which is in electrical communication with mobile computing device 101, accepts the control signal, decodes it and passes the control data on to pointer device driver software and the operating system of mobile computing device 101.

In some embodiments, communication between receiver dongle 130 and mobile pointing device 120 of mobile user input device 110 can be implemented using any of the known wireless communication methodologies, such as, for example infrared, radio frequency (RF), including, but not limited to, Bluetooth® and 802.11b/g standards, a proprietary RF operating at 27 Megahertz (MHz) frequency and the like. Wireless pointing devices are know in the art and will not be discussed further.

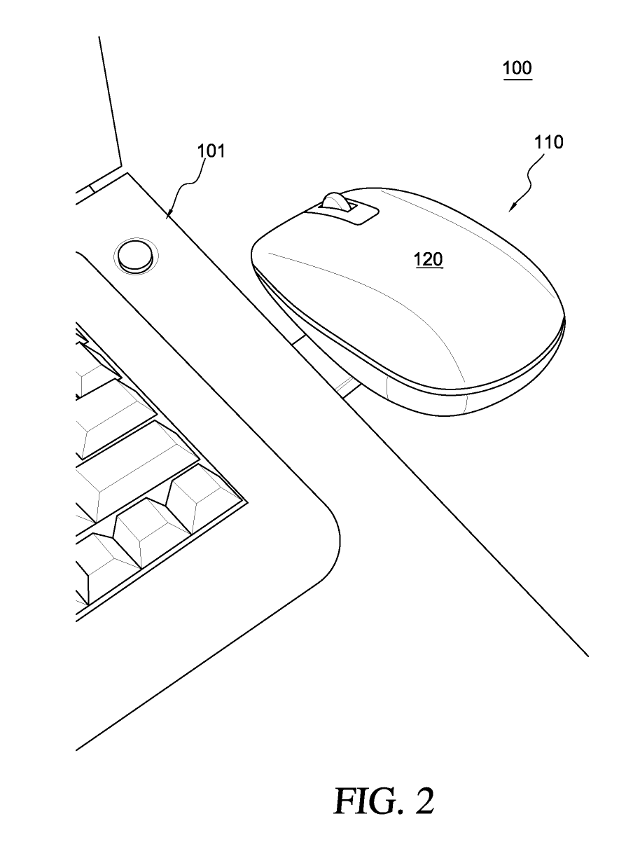

FIG. 2 illustrates exemplary mobile computing system 100 for providing user input via mobile user input device 110 wherein mobile user input device 110 is in “storage mode.” Elements numbered substantially similar to elements in FIG. 1 above perform in a substantially similar way.

In operation and described below, a portion of each of mobile pointing device 120 and receiver dongle 130 (not shown) includes magnetic material such that when the magnetic portion of mobile pointing device 120 is in close proximity to the magnetic portion of receiver dongle 130, the devices are magnetically drawn to one another due to the magnetic properties of the magnetic materials incorporated within mobile pointing device 120 and receiver dongle 130. In other embodiments, either mobile pointing device 120 or receiver dongle 130 includes magnetic material (e.g., ceramic magnet, alnico magnet, neodymium and the like) while the other element includes a substance (e.g., iron, nickel and the like) that attracts or is attracted to the magnetic material.

In some examples, during operation/non-operation of a stationary computing device (e.g., a personal computing device), mobile pointing device 120 can be stored while magnetically connected to the magnetic portion of receiver dongle 130, such as, when receiver dongle 130 is in mechanical communication with a stationary computing device. In other examples, during operation/non-operation of a mobile computing device, such as for example mobile computing device 101, mobile pointing device 120 can be stored while magnetically connected to the magnetic portion of receiver dongle 130, such as, when receiver dongle 130 is in mechanical communication with mobile computing device 101. In yet other examples, during non-operation of a stationary computing device or mobile computing device 101, mobile pointing device 120 can be stored while magnetically connected to the magnetic portion of receiver dongle 130, such as, in a location separate from the stationary computing device or mobile computing device 101.

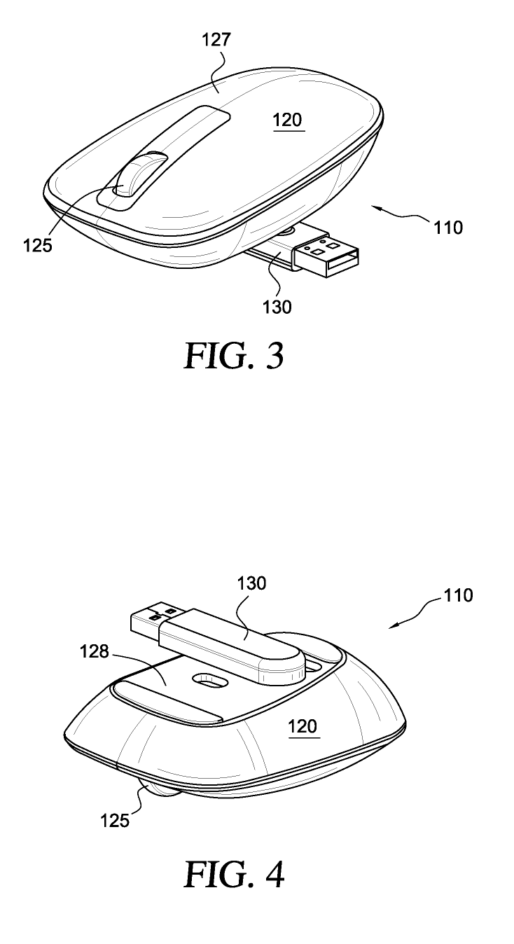

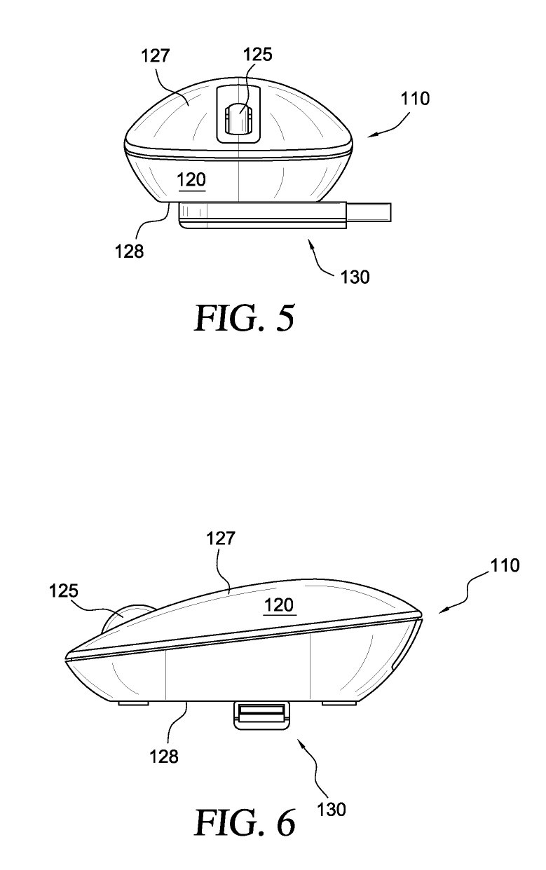

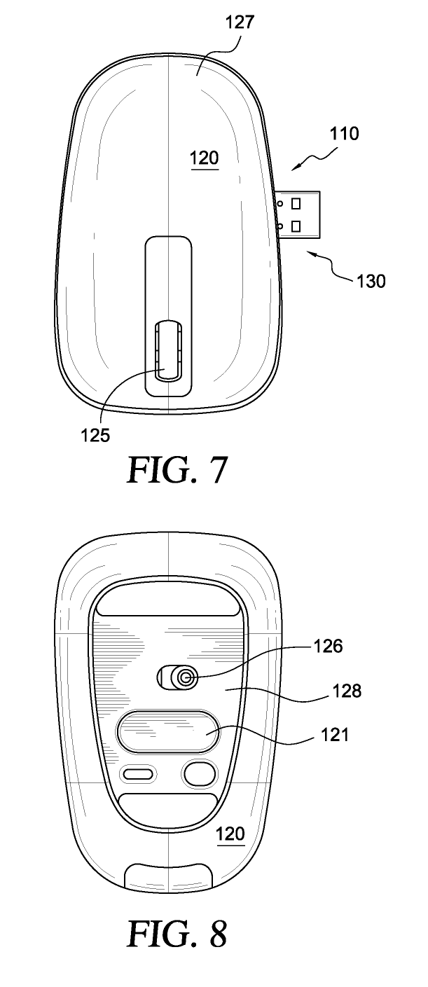

FIGS. 3-7 illustrate exemplary mobile user input device 110 from various viewing angles and details mobile user input device 110 in “storage mode” and includes mobile pointing device 120 and receiver dongle 130 in magnetic communication with one another. Elements numbered substantially similar to elements in FIGS. 1 and 2 above perform in a substantially similar way.

In FIGS. 3-7 mobile pointing device 120 portion of mobile user input device 110 includes a top side 127 and a bottom side 128. In some embodiments, the top side can include input elements configured to receive input from the user of mobile pointing device 120. An example of an input element can include a scroll wheel 125. Other examples can include, one or more buttons and a trackball. Mobile pointing device 120 can also include input elements not specifically disclosed. In addition, mobile pointing device can include other elements not relevant to the discussion.

In some embodiments, the external housings of mobile pointing device 120 and receiver dongle 130 can be manufactured from any suitable materials, such as, for example acrylonitrile butadiene styrene (ABS) plastic, as available from General Electric (GE) Plastics of Pittsfield, Mass., but could be manufactured from other rigid or semi-rigid thermoplastic materials such as polycarbonate plastic or polystyrene plastic.

FIG. 8 illustrates an exemplary mobile pointing device 120 portion of an exemplary mobile user input device 110 for transmitting user input to a computing device. In FIG. 8, mobile pointing device 120 additionally includes a mobile pointing attraction strip 121 as well as a sensory array 126 as well as other elements not relevant to the discussion. In the example of FIG. 8, mobile pointing attraction strip 121 and sensory array 126 are located on bottom side 128. In some examples, sensor array 126 comprises a light emitting diode (LED) sensor array. In other examples, sensor array comprises a trackball sensor array. Sensory array 126 can also comprise other types of sensor arrays not specifically mentioned. Elements numbered substantially similar to elements in FIGS. 1-7 above perform in a substantially similar way.

In some embodiments, the LED well in which sensor array 126 is located provides a transmission and reception path so as to allow an LED housed within mobile pointing device 120 to provide movement data associated with mobile pointing device 120 to the computing device. Movement data is part of control data.

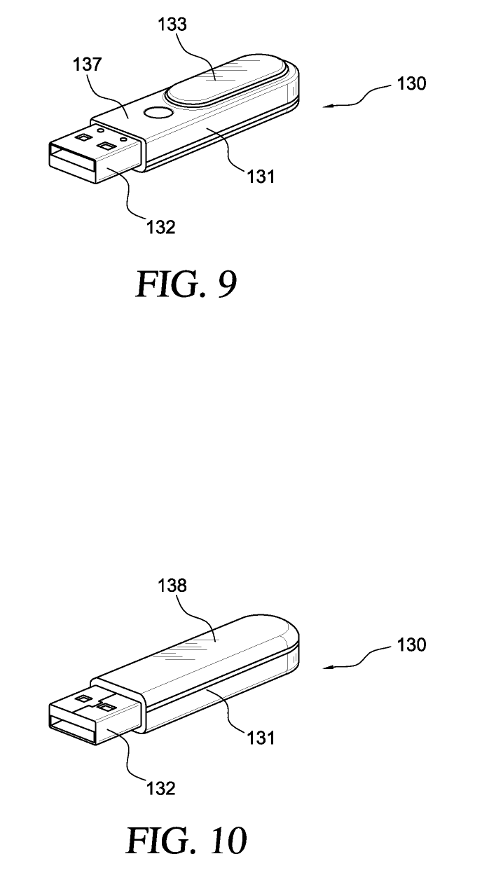

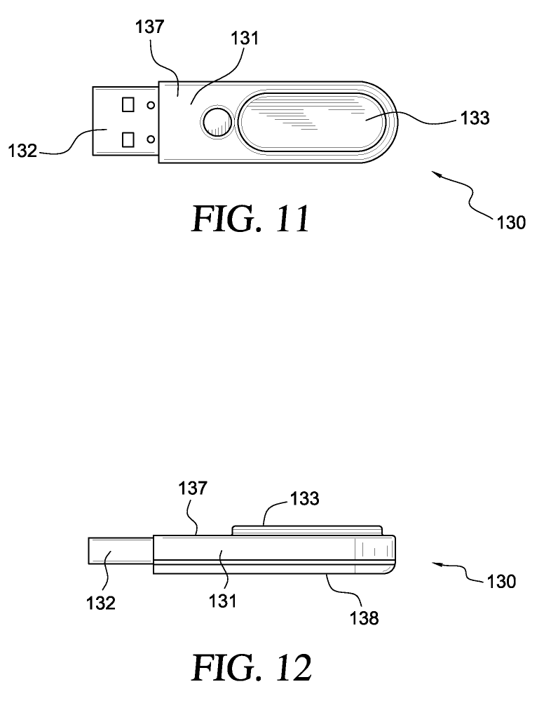

In some embodiments, mobile pointing attraction strip 121 provides an area where magnetic materials can be located. In such embodiments, the magnetic materials located within mobile pointing attraction strip 121 allow mobile pointing device 120 to magnetically couple with receiver dongle 130 (detailed in FIGS. 9-12, below) and may result in mobile user input device 110 deploying in “storage mode.” In some embodiments, mobile pointing attraction strip 121 provides an area where magnetic attracting materials can be located. In such embodiments, the magnetic attracting materials located within mobile pointing attraction strip 121 allow mobile pointing device 120 to magnetically couple with receiver dongle 130 (detailed in FIGS. 9-12, below) and may result in mobile user input device 110 deploying in “storage mode.” The magnetic materials and/or magnetic attracting materials can be affixed to mobile pointing attraction strip 121 of mobile pointing device 120 using any suitable method, such as, for example, using an adhesive or by enclosing the magnetic materials and/or magnetic attracting materials within any of the rigid or semi-rigid thermoplastic materials listed above and thermo-coupling the encasing to mobile pointing device 120 in the location of mobile pointing attraction strip 121. In some examples, mobile pointing attraction strip 121 is approximately 27 millimeters (mm) long, 8 mm wide, and 1.5 mm thick. In other examples mobile pointing attraction strip 121 can be greater than or less than 27 mm long, greater than or less than 8 mm wide, or greater than or less than 1.5 mm thick.

FIGS. 9-12 illustrate exemplary receiver dongle 130 portion of exemplary mobile user input device 110 for receiving user input to a computing device. Receiver dongle includes a top 137 and a bottom 138. In FIGS. 9-12, receiver dongle 130 additionally includes dongle housing 131, dongle coupler 132 and dongle attraction strip 133 as well as other elements not relevant to the present discussion. Elements numbered substantially similar to elements in FIGS. 1-7 above perform in a substantially similar way.

In some embodiments, dongle housing 131 includes all necessary hardware, firmware and the like to perform some or all functionality associated with receiving control signals from mobile pointing device 120. In the same or other embodiments, dongle coupler 132 is in mechanical and/or electrical communication with dongle housing 131 and is configured to couple receiver dongle 130 to an associated coupler portion of a computing device.

In some embodiments, top 137 of dongle 130 can include a dongle attraction strip 133. Dongle attraction strip 133 provides an area where magnetic materials can be located. In such embodiments, the magnetic materials located within dongle attraction strip 133 allow receiver dongle 130 to magnetically couple with mobile pointing device 120 (detailed in FIG. 8, above) and may result in mobile user input device 110 deploying in “storage mode.” In other embodiments, dongle attraction strip 133 provides an area where magnetic attracting materials can be located. In such embodiments, the magnetic attracting materials located within dongle attraction strip 133 allow receiver dongle 130 to magnetically couple with mobile pointing device 120 (detailed in FIG. 8, above) and may result in mobile user input device 110 deploying in “storage mode.” The magnetic materials and/or magnetic attracting materials can be affixed to dongle attraction strip 133 of receiver dongle 130 using any suitable method, such as, for example, using an adhesive or by enclosing the magnetic materials and/or magnetic attracting materials within any of the rigid or semi-rigid thermoplastic materials listed above and thermo-coupling the encasing to receiver dongle 130 in the location of dongle attraction strip 133. In some examples, dongle attraction strip 133 is approximately 16 mm long, 8 mm wide, and 1.5 mm thick. In other examples dongle attraction strip 133 can be greater than or less than 16 mm long, greater than or less than 8 mm wide, or greater than or less than 1.5 mm thick.

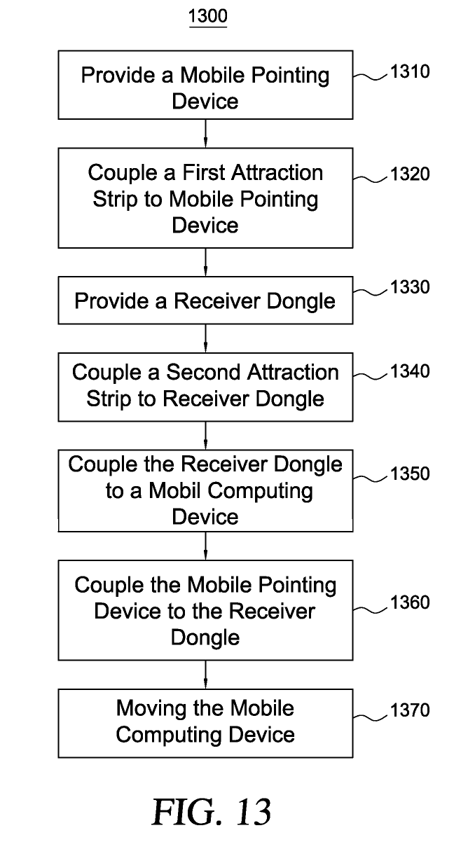

FIG. 13 is a flow chart illustrating an exemplary method 1300 of providing a portable pointing device assembly. As an example, the portable pointing device assembly can be the same as or similar to mobile user input device 110 (FIG. 1-7). Method 1300 is merely exemplary an is not limited to the embodiments presented herein. Method 1300 can be employed in many different embodiments or examples not specifically depicted herein.

Method 1300 includes a procedure 1310 of providing a mobile pointing device. The mobile pointing device can be the same as or similar to mobile pointing device 120 (FIG. 1-8).

Next, method 1300 includes a procedure 1320 of coupling a first attraction strip to the mobile pointing device. The first attraction strip can be the same as or similar to mobile pointing device attraction strip 121 (FIG. 8) The first attraction strip can be coupled to the mobile pointing device via any suitable method, such as, for example, using an adhesive or by enclosing the first attraction strip within the materials of the mobile pointing device and thermo-coupling the encasing of the mobile pointing device in the location of the first attraction strip.

After procedure 1320, method 1300 continues with a procedure 1330 of providing a receiver dongle. The receiver dongle can be the same as or similar to receiver dongle 130 (FIGS. 1, 3-7, and 9-12).

Subsequently, method 1300 includes a procedure 1340 of coupling a second attraction strip to the receiver dongle. The second attraction strip can be the same as or similar to receiver dongle attraction strip 133 (FIGS. 9, 11, and 12). The second attraction strip can be coupled to the receiver dongle via any suitable method, such as, for example, using an adhesive or by enclosing the second attraction strip within the materials of the receiver dongle and thermo-coupling the encasing of the receiver dongle in the location of the second attraction strip. It should be noted that the first attraction strip should be coupled to the mobile pointing device and the second attraction strip coupled to the receiver dongle in such a way that first attraction strip and the second attraction strip are configured to be coupled when the mobile pointing device is in proximity to the receiver dongle.

Next, method 1300 continues with a procedure 1350 of coupling the receiver dongle of procedure 1330 to a mobile computing device. In one embodiment, the mobile computer device of procedure 1350 is mobile computer device 101 in FIG. 1. In the same or different embodiment, the receiver dongle is electrically and physically coupled to the mobile computing device.

Then, method 1300 continues with a procedure 1360 of coupling the mobile pointing device of procedure 1310 to the receiver dongle of procedure 1330. In one embodiment, procedure 1350 can be performed by magnetically coupling the first attraction strip of the mobile pointing device to the second attraction strip of the receiver dongle.

Afterwards, method 1300 includes a procedure 1370 of moving the mobile computing device. In one embodiment, the mobile computer device is moved while the receiver dongle remains physically coupled to the mobile computer device and while the mobile pointing device remains magnetically coupled to the receiver dongle.

Although the method 1300 has been described with various methods in a particular order, it will be understood by those skilled in the art that the order of the various procedures can be interchanged. For example, procedures 1330 and 1340 can occur before 1310 and 1320. In addition, procedures 1310 and 1330 can occur before 1320 and 1340.

Although aspects of the subject matter described herein have been described with reference to specific embodiments, it will be understood by those skilled in the art that various changes may be made without departing from the scope of the subject matter described herein. Accordingly, the disclosure of embodiments is intended to be illustrative of the scope of the subject matter described herein and is not intended to be limiting. It is intended that the scope of the subject matter described herein shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the subject matter described herein and claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A portable pointing device assembly, comprising:
a mobile pointing device, the mobile pointing device having a top side and a bottom side, the top side having at least one user input, the bottom side having a sensor array, the mobile pointing device configured to receive user input and provide control data that is based on the user input to a computing device;
a first attraction strip, the first attraction strip coupled to the mobile pointing device;
a receiver dongle, the receiver dongle having a dongle housing and a dongle coupler in mechanical and electrical communication with the dongle housing, the dongle coupler in removable physical communication with the computing device, the receiver dongle in communication with the mobile pointing device, the receiver dongle configured to receive the control data from the mobile pointing device and provide the control data to the computing device; and
a second attraction strip, the second attraction strip coupled to the receiver dongle; and
wherein the first attraction strip and the second attraction strip are configured to magnetically couple together when the mobile pointing device is in proximity to the receiver dongle.

2. The portable pointing device assembly of claim 1, wherein the first attraction strip is coupled to the mobile pointing device with an adhesive.

3. The portable pointing device assembly of claim 1, wherein the first attraction strip is coupled to the mobile pointing device by encasing the first attraction strip within the mobile pointing device.

4. The portable pointing device assembly of claim 3, wherein the first attraction strip is located within the bottom side of the mobile pointing device.

5. The portable pointing device assembly of claim 1, wherein the second attraction strip is coupled to the receiver dongle with an adhesive.

6. The portable pointing device assembly of claim 1, wherein the second attraction strip is coupled to the receiver dongle by encasing the second attraction strip within the dongle housing.

7. The portable pointing device assembly of claim 6, wherein the receiver dongle has a top and a bottom and the second attraction strip is coupled to the receiver dongle by encasing the second attraction strip within the top of the receiver dongle.

8. The portable pointing device assembly of claim 1, wherein the mobile pointing device is in wireless communication with the receiver dongle.

9. The portable pointing device assembly of claim 1, wherein the sensor array comprises at least one of: a trackball sensor array or a light-emitting diode sensor array.

10. The portable pointing device assembly of claim 1, wherein the at least one user input comprises at least one of: a button, a scroll wheel or a trackball.

11. A wireless portable pointing device assembly, comprising:
a mobile pointing device, the mobile pointing device having a top side and a bottom side, the top side having at least one user input, the bottom side having a sensor array and a mobile pointing device attraction strip, the mobile pointing device configured to receive user input and provide control data that is based on the user input to a computing device; and
a receiver dongle, the receiver dongle having a dongle housing and a dongle coupler in mechanical and electrical communication with the dongle housing, the dongle coupler in removable physical communication with the computing device, the dongle housing having a receiver dongle attraction strip, the receiver dongle in wireless communication with the mobile pointing device, the receiver dongle configured to receive the control data from the mobile pointing device and provide the control data to the computing device;
wherein the mobile pointing attraction strip and the receiver dongle attraction strip are configured to be magnetically coupled together when the mobile pointing device is in proximity to the receiver dongle.

12. The wireless portable pointing device assembly of claim 11, wherein the receiver dongle has a top and a bottom and the receiver dongle attraction strip is located on the top of the receiver dongle.

13. The wireless portable pointing device assembly of claim 11, wherein the sensor array comprises at least one of: a trackball sensor array or a light-emitting diode sensor array.

14. The wireless portable pointing device assembly of claim 11, wherein the at least one user input comprises at least one of: a button, a scroll wheel or a trackball.

15. The wireless portable pointing device assembly of claim 11, wherein at least one of the mobile pointing attraction strip or the receiver dongle attraction strip comprises a magnetic material.

16. A method of providing a portable pointing device assembly, comprising:
providing a mobile pointing device;
coupling a first attraction strip to the mobile pointing device;
providing a receiver dongle; and
coupling a second attraction strip to the receiver dongle;
wherein the first attraction strip and the second attraction strip are configured to be magnetically coupled together when the mobile pointing device is in proximity to the receiver dongle.

17. The method of claim 16, wherein coupling the first attraction strip to the mobile pointing device comprises using an adhesive to attach the first attraction strip to the mobile pointing device.

18. The method of claim 16, wherein coupling the first attraction strip to the mobile pointing device comprises encasing the first attraction strip within the mobile pointing device.

19. The method of claim 16, wherein coupling the second attraction strip to the receiver dongle comprises using an adhesive to attach the second attraction strip to the receiver dongle.

20. The method of claim 16, wherein coupling the second attraction strip to the receiver dongle comprises encasing the second attraction strip within the receiver dongle.
